(19) United States
(12) Patent Application Publication
(10) Pub. No.: US 2009/0037885 A1
(43) Pub. Date: Feb. 5, 2009

(54) EMULATING EXECUTION OF DIVERGENT PROGRAM EXECUTION PATHS

(75) Inventors: ANDREW J. EDWARDS, BELLEVUE, WA (US); J. JORDAN TIGANI, SEATTLE, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORORATION, REDMOND, WA (US)

(21) Appl. No.: 11/830,572

(22) Filed: Jul. 30, 2007

(51) Int. Cl. G06F 9/44

(52) U.S. Cl. 717/128

(57) ABSTRACT

Methods, systems, and computer storage media having computer-executable instructions embodied thereon that, when executed, perform methods in accordance with embodiments hereof, for emulating execution of divergent program execution paths to determine whether any “would be” program defects exist in a particular divergent program execution path and/or to determine the nature of such “would be” program defects are provided. The dynamic execution state (e.g., register values and memory locations) of a program being executed is cloned at a point of potential divergence and a virtual processor having the same dynamic execution state is generated. Subsequently, utilizing the virtual processor, a test trace is initiated along the divergent program execution path and information gathered during the test trace is analyzed to identify any program defects that may have occurred had the program execution followed the divergent path.

### BACKGROUND

Debugging computer software can be a particularly challenging endeavor. Software defects (“bugs”) are notoriously difficult to locate and analyze. Various approaches have been used to simplify debugging. For example, static program analysis can analyze a program to detect potential bugs. A programmer can then modify the program as appropriate. However, static analysis techniques are limited in their ability and usefulness in locating bugs and have a tendency to create false-positive conditions. Accordingly, some defects are located only by execution testing.

To achieve executable software testing, various execution scenarios are tested for observable defects, such as program crashes or other errors. While testing and debugging are useful, there are some defects that may not appear even in extensive testing as traditional dynamic analysis only follows paths that are actually executed within a program. For example, memory leaks may not be detected within the program if the memory is not allocated along the executed path is not accessed or if the program encounters a defect and crashes before reaching the memory leak. Accordingly, these tools are unable to analyze programs for potential bugs with a robust path coverage.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

When a program is executed, it follows a particular execution path. Generally, however, even if the execution is successful and no program defects are detected, there are multiple locations along the path where execution could have taken a turn that would have defined a different execution path. Had the program taken such a turn, a program defect may or may not have been encountered. In order to identify such “would be” program defects (or to determine that no such “would be” program defect exists in a particular divergent execution path), embodiments of the present invention relate to methods and systems for emulating execution of one or more divergent program execution paths. The dynamic execution state (e.g., register values and memory locations) of the program at a point of potential divergence is cloned and a virtual processor having such dynamic execution state is generated. Subsequently, a test trace is initiated along the divergent program execution path and information gathered during the test trace is analyzed to identify any program defects that may have occurred had the program execution followed the divergent path.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary computing system suitable for use in implementing embodiments of the present invention;

FIG. 3 is a flow diagram showing a method for providing a notification of a program condition incident to performing a multi-path dynamic test with a virtual processor, in accordance with an embodiment of the present invention;

FIG. 4 is an exemplary schematic to illustrate multi-path dynamic testing, in accordance with an embodiment of the present invention;

FIG. 5 is a flow diagram showing a method for executing instructions on multiple, alternate, or nested, divergent execution paths, in accordance with an embodiment of the present invention; and

FIG. 6 is a flow diagram continuing from FIG. 5, showing further steps in the method for executing instructions on multiple, alternate, or nested divergent execution paths, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention relate to methods, systems, and computer storage media having computer-executable instructions embodied thereon that, when executed, perform methods in accordance with embodiments hereof, for emulating execution of divergent program execution paths to determine whether any “would be” program defects exist in a particular divergent program execution path and/or to determine the nature of such “would be” program defects. The dynamic execution state (e.g., register values and memory locations) of the program at a point of potential divergence is cloned and a virtual processor having the same dynamic execution state is generated. Subsequently, a test trace is initiated along the divergent program execution path and information gathered during the test trace is analyzed to identify any program defects that may have occurred had the program execution followed the divergent path.

Accordingly, in one aspect, embodiments of the present invention relate to one or more computer storage media having computer-executable instructions embodied thereon that, when executed, perform a method for executing divergent execution paths associated with a program. The method includes executing a first program execution path, the first program execution path having at least one point of divergence associated therewith that defines a second execution path, generating a virtual processor having an execution state that emulates a dynamic execution state of the program at the point of potential divergence associated with the first program execution path, executing a test trace along the second program execution path utilizing the virtual processor, and storing information associated with the test trace and the second program execution path in association with at least one data store.

In another aspect, embodiments of the present invention relate to a computer system embodied on one or more computer storage media having computer-executable instructions embodied thereon for performing a method for emulating execution of divergent execution paths associated with a program. The system includes a program execution component configured for executing a plurality of instruction-level traces, each instruction-level trace being associated with a different program execution path; a generating component configured for generating at least one virtual processing unit, the at least one virtual processing unit being associated with one of the plurality of instruction-level traces; and an analysis component configured for analyzing information associated with the one of the plurality of instruction-level traces associated with the virtual processing unit.

In yet another aspect, embodiments of the present invention relate to one or more computer storage media having computer-executable instructions embodied thereon that, when executed, perform a method for emulating execution of divergent program execution paths. The method includes initiating a trace of a program along a first execution path, the first execution path having a point of potential divergence associated therewith that defines a second execution path; determining a dynamic execution state of the program at the point of potential divergence associated with the first execution path; generating a virtual processor having the dynamic execution state of the program at the point of potential divergence associated with the first execution path; initiating a test trace along the second execution path utilizing the virtual processor; and storing information associated with at least one of the test trace and the second execution path in association with at least one data store.

Having briefly described an overview of embodiments of the present invention, an exemplary operating environment suitable for implementing the present invention is described below.

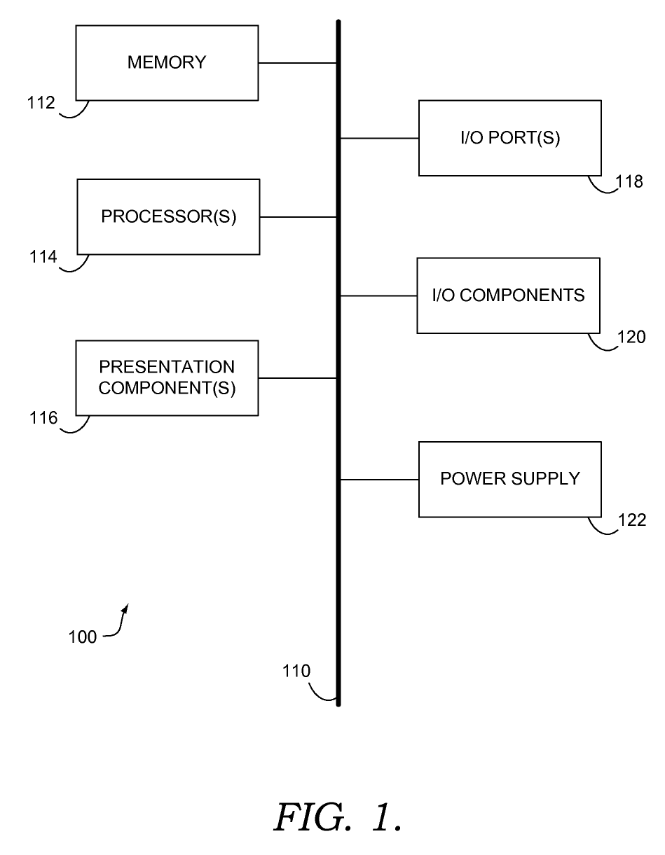

Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing environment 100 be interpreted as having any dependency or requirement relating to any one or combination of components illustrated.

The invention may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. Embodiments of the present invention may be practiced in a variety of system configurations, including hand-held devices, consumer electronics, general-purpose computers, specialty computing devices, etc. Embodiments of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVDs) or other optical or holographic media; magnetic cassettes, magnetic tape, magnetic disk storage or other magnetic storage devices, or any other medium that can be used to encode desired information and be accessed by computing device 100.

Memory 112 includes computer storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc. I/O ports 118 allow computing device 100 to be logically coupled to other devices including I/O components 120, some of which may be built in. Illustrative components include a microphone, joystick, game pad, satellite dish, scanner, printer, wireless device, etc.

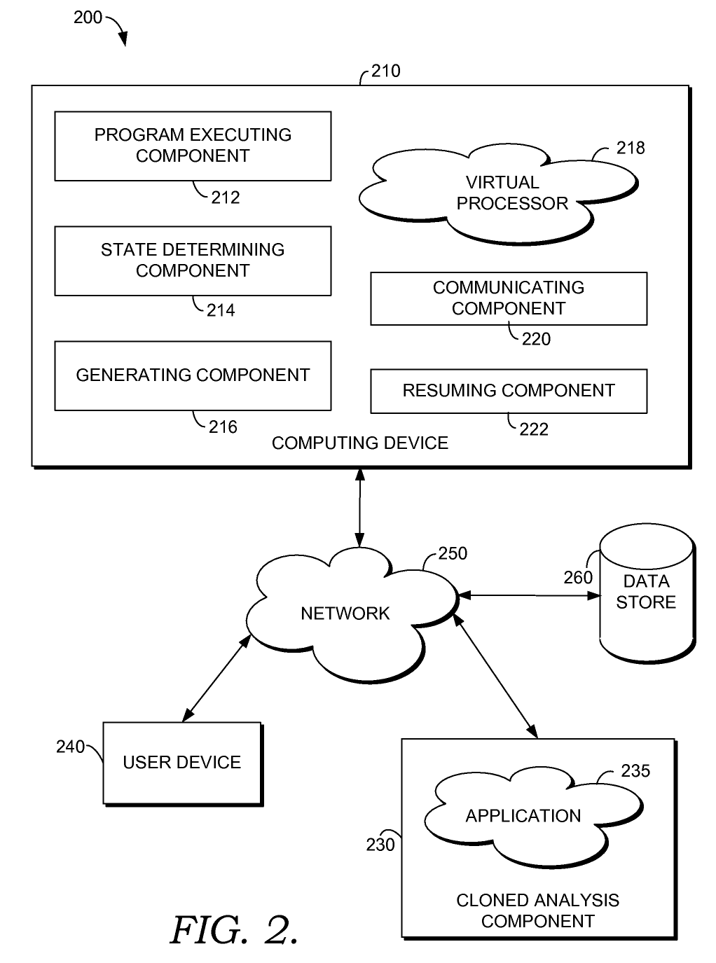

Turning now to FIG. 2, a block diagram is illustrated, in accordance with an embodiment of the present invention, showing a program execution analysis system 200 configured to emulate execution of divergent execution paths and analyze program execution information gathered during such emulated execution. It will be understood and appreciated by those of ordinary skill in the art that the execution analysis system 200 shown in FIG. 2 is merely an example of one suitable computing system environment and is not intended to suggest any limitation as to the scope of use or functionality of embodiments of the present invention. Neither should the execution analysis system 200 be interpreted as having any dependency or requirement related to any single component or combination of components illustrated therein. Further, the program execution analysis system 200 may be provided as a stand-alone product, as part of a software development environment, or any combination thereof.

The execution analysis system 200 includes a computing device 210, an analysis component 230, a user device 240, and a data store 260 all in communication with one another via a network 250. The network 250 may include, without limitation, one or more local area networks (LANs) and/or wide area networks (WANs). Such networking environments are commonplace in offices, enterprise-wide computer networks, intranets, and the Internet. Accordingly, the network 250 is not further described herein.

The data store 260 is configured to store program execution information associated with at least one trace. In various embodiments, such information may include, without limitation, information related to trace execution paths, information related to test trace execution paths, the nature of program defects, the location of program defects, and the like. In embodiments, the data store 260 is configured to be searchable for one or more of the items stored in association therewith. It will be understood and appreciated by those of ordinary skill in the art that the information stored in the data store 260 may be configurable and may include any information relevant to program execution. The content and volume of such information are not intended to limit the scope of embodiments of the present invention in any way. Further, though illustrated as a single, independent component, data store 260 may, in fact, be a plurality of data stores, for instance, a database cluster, portions of which may reside on the user device 240, the computing device 210, the cloned analysis component 230, another external computing device (not shown), and/or any combination thereof.

Each of the computing device 210, the analysis component 230, and the user device 240 shown in FIG. 2 may be any type of computing device, such as, for example, computing device 100 described above with reference to FIG. 1. By way of example only and not limitation, each of the computing device 210, the cloned analysis component 230, and the user device 240 may be a personal computer, desktop computer, laptop computer, handheld device, mobile handset, consumer electronic device, and the like. Additionally, the user device 240 may further include a keyboard, keypad, stylus, joystick, and any other input-initiating component that allows a user (e.g., a software developer or a programmer) to provide wired or wireless data to the network 250. It should be noted, however, that the present invention is not limited to implementation on such computing devices, but may be implemented on any of a variety of different types of computing devices within the scope of embodiments hereof.

As shown in FIG. 2, the computing device 210 is configured to execute multiple program paths via emulation of a dynamic analysis tool. Execution is performed by a virtual processor that utilizes a representation of a dynamic-execution state during execution of the multiple program paths. The computing device 210 includes a program executing component 212, a state determining component 214, a generating component 216, a virtual processor 218, a communicating component 220, and resuming component 222. In some embodiments, one or more of the illustrated components 212, 214, 216, 218, 220, and 222 may be implemented as stand-alone applications. In other embodiments, one or more of the illustrated components 212, 214, 216, 218, 220, and 222 may be integrated directly into the operating system of the computing device 210 and/or the user device 240. By way of example only, the communicating component 220 may be housed in association with the computing device 210, or may be incorporated within the virtual processor 218. It will be understood by those of ordinary skill in the art that the components 212, 214, 216, 218, 220, and 222 illustrated in FIG. 2 are exemplary in nature and in number and should not be construed as limiting. Any number of components may be employed to achieve the desired functionality within the scope of embodiments of the present invention.

The program executing component 212 is configured for executing a plurality of traces, e.g., instruction-level traces, each trace being associated with a different program execution path. Typically, the program executing component 212 executes a sequence of operations along an initial trace of a program while communicating information gathered during the trace to an analysis engine. During execution of the trace, the processor may encounter one or more points of potential path divergence, that is, points at which the execution may follow any one of a plurality of different execution paths. Examples of such points of potential path divergence include, without limitation, a point at which an allocation function could have failed, a point at which a network operation could have returned a timeout, or a point at which a potential race condition could have been detected. Thus, the program executing component 212 is configured for executing a sequence of operations along a test trace of the program, the test trace following a path that diverges from the initial trace execution path at a point of divergence. In this way, execution of alternate or divergent paths may be emulated and potential “would be” program defects may be identified, as more fully described below.

The state determining component 214 is configured to determine a dynamic execution state of the program, e.g., by extracting a dynamic execution state from the program computing environment. Typically, the dynamic execution state of the program will be determined by the state determining component 214 as it exists at a particular point of path divergence. The dynamic execution state may include state changes of the computing environment or other data related to the processor state (e.g., register values, memory locations, component addresses, and the like). Accordingly, by determining the dynamic execution state, the conditions of the computing environment at a particular point (typically a point of divergence) may be replicated. Further, these replicated conditions allow a virtual processor to operate in an isolated state such that executing program instructions by the virtual processor will not affect the computing environment prior to returning to the initial trace. Use of the determined dynamic execution state in association with a virtual processor is more fully described below.

The generating component 216 is configured to generate a virtual processor 218 having the dynamic execution state of the program at the determined point, e.g., at the point of execution path divergence. That is, a virtual processor 218 is generated that simulates the actual processor when executing instructions within the program and the communicating program execution information to an analysis engine. As used herein, the term “program-execution information” refers to a stream of executed instructions (e.g., affected register values, altered memory locations, arithmetic operations, object allocations, etc.), events (e.g., read events, write events, calls, returns, bugs, defects, etc.), or any other information that provides details of the execution of a program. However, use of “program execution information” should not be construed as limiting and may encompass any program condition that may be encountered during program testing.

Further, the generating component 216 is configured to generate a clone of an actual analysis component (e.g., cloned analysis component 230), configured for analyzing information gathered during the initial trace execution. The cloned analysis component 230 is more fully described below. In operation, the cloned analysis component 230 functions similar to the actual analysis component (not shown), but is additionally capable of receiving communications from the virtual processor 218 without affecting the mainline analysis being conducted utilizing the actual analysis component.

The virtual processor 218 is configured to execute instructions of the program along an execution path that is divergent from the execution path of the initial trace. In one embodiment, the virtual processor 218 is configured as a central processing unit (CPU). Typically, the virtual processor 218 executes these instructions along the divergent execution path in a manner that replicates the performance of the actual processor when executing instructions along the execution path of the initial trace. Thus, the virtual processor 218 approximates the behavior of the actual processor had it followed the divergent execution path. However, dissimilar to the actual processor, the virtual processor 218 is supported by the information from the dynamic execution state and does not affect the state of the computing environment.

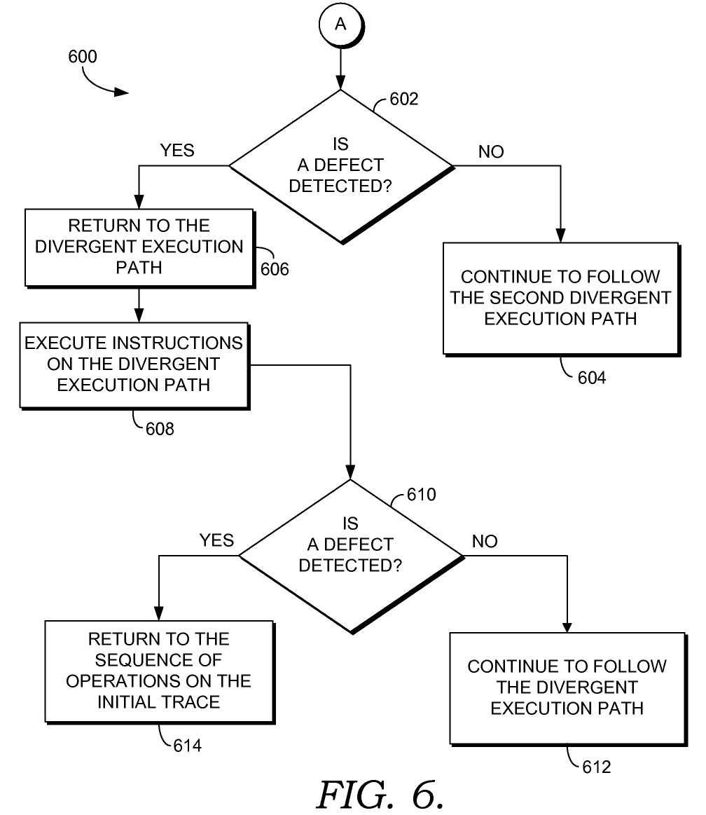

During execution of the instructions on the divergent execution path, the virtual processor 218 may encounter defects in the program, that is, “would be” defects that may have been encountered had the initial path instead taken an alternate route. In one embodiment, upon detecting the defect, the virtual processor 218 will cease executing instructions. This embodiment is discussed more fully below with reference to FIG. 6. Additionally, upon detection of a program defect, the virtual processor 218 may communicate information related to the program defect, or other faults experienced during execution, to an analysis component (e.g., cloned analysis component 230). This communication emulates a communication from the actual processor so that the cloned analysis component 230 may read and interpret the information. As used herein, the term “defect” or “program defect” refers to a bug (e.g., a race condition, a memory leak, a fatal error, use of uninitialized memory, a buffer overrun, etc.). However, use of “defect” should not be construed as limiting and may encompass any inconsistency in the program code.

The communicating component 220 is configured to communicate program execution information gathered during execution of one or more instructions by the virtual processor 218. That is, upon encountering a program defect, the virtual processor 218 may communicate an indication of the defect to the cloned analysis component 230, or to the computing device 210. In the latter instance, the communicating component 220 may communicate the indication of the program defect to the cloned analysis component 230. The communicating component 220 may also transmit other program execution information discovered incident to the virtual processor 218 executing instructions on the divergent execution path. Further, the communicating component 220 may receive feedback from the actual analysis component, which may be utilized by the virtual processor 218 during testing of the program.

The resuming component 222 is configured to cease the virtual processor 218 from executing instructions in the divergent execution path. Typically, a command to cease execution is generated incident to detecting a defect in the program. However, because the virtual processor operates similar to an actual processor, not each defect will generate the command. If a race condition or memory leak is encountered (that is, a non-fatal error), then the virtual processor 218 will continue executing instructions. However, if an allocation function points to uninitialized memory (that is, a failure condition), then the virtual processor 218 will be commanded to cease execution, similar to an actual processor crashing.

The resuming component 222 is further configured to command the actual processor to resume testing the initial trace of the program. This is discussed more fully below with reference to FIG. 6. In one embodiment, the actual processor and the virtual processor 218 execute instructions in parallel. Accordingly, the virtual processor 218 may be omitted in this embodiment as a command to the actual processor to resume testing would be redundant.

The cloned analysis component 230, typically derived from an actual analysis component (not shown), is configured to analyze program execution information provided or gathered upon testing a divergent execution path of a program. Accordingly, the cloned analysis component 230 is configured to receive program execution information. In one embodiment, an application 235 is embedded on the cloned analysis component 230. The application 235 is an execution analysis tool configured to analyze the received program execution information and, if indicated by the analysis, notify of one or more program conditions. Analyzing the program execution information includes identifying a sequence of operations from the program execution information, evaluating the sequence of operations, and determining whether a program condition exists. A program condition, as used herein, refers to the product of an analysis and may include, but is not limited to, a bug, test criteria, satisfied code expressions, and the like. Notifying of the program conditions includes conveying to the communicating component 220 of the computing device 210, or user device 240, an indication of the program condition.

The user device 240, in one embodiment, is configured to provide a user interface to present feedback (e.g., indication of a program condition) from the cloned analysis component 230 to a user (e.g., programmer or software developer). Utilizing the feedback, the user may attempt to find the source of the program condition (e.g., manifestation of a bug) and its cause. Upon discovering the program condition, the user is able to modify the program as appropriate. In another embodiment, the user device 240, is capable of receiving input from the user at the user interface. This input may be in reaction to feedback, or may be directed to starting, modifying, and/or ceasing the multi-path dynamic testing process.

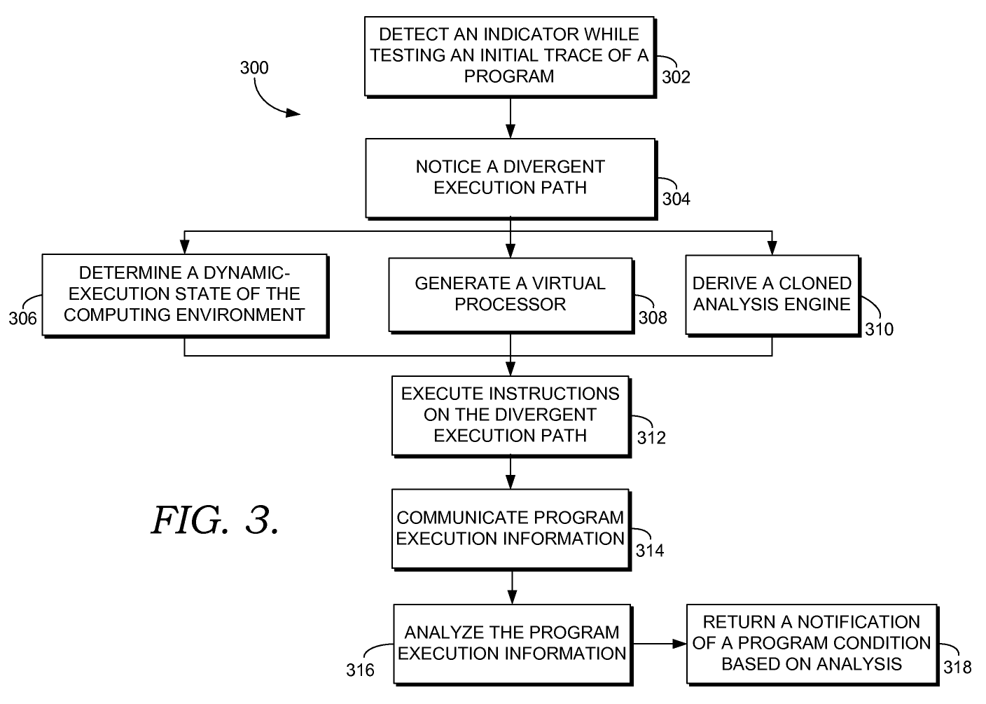

Turning now to FIG. 3, a flow diagram is illustrated that shows a method 300 for providing a notification of a program condition incident to performing a multi-path dynamic test with a virtual processor, in accordance with an embodiment of the present invention. Initially, as indicated at block 302, an indicator (e.g., allocation function) is detected while testing the initial trace of a program, e.g., utilizing program executing component 212. If the indicator points to a divergent execution path in the program that may be taken by the processor, as indicated a block 304, several steps are taken. These steps (e.g., blocks 306, 308, and 310) may be taken in any order or concomitantly. As indicated at block 306, a dynamic execution state is determined from the computing environment, typically upon detecting an indicator, e.g., utilizing state determining component 214. As indicated at blocks 308 and 310 respectively, a virtual processor is generated and a cloned analysis component is derived, e.g., utilizing generation component 216. Next, the virtual processor executes instructions on the divergent execution path, e.g., utilizing the virtual processor 218. This is indicated at block 312. Incident to execution, program execution information is communicated to the cloned analysis component (as indicated at block 314), e.g., utilizing the communicating component 220, that analyzes the program execution information (as indicated at block 316). If the cloned analysis component identifies an event within the program execution information, a notification may be generated with an indication of a program condition, associated with the event, appended thereto.

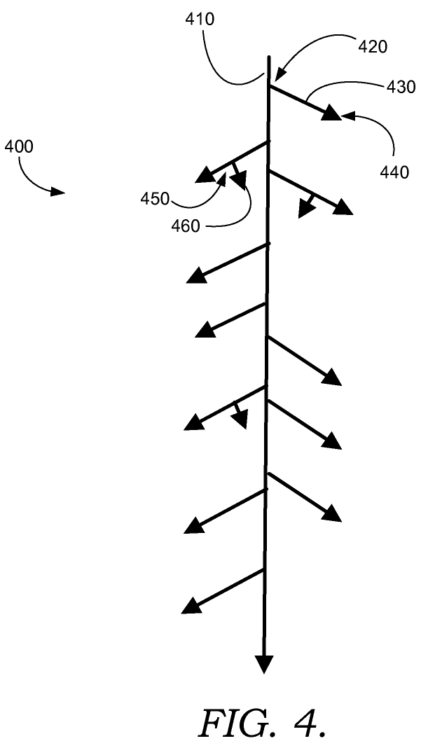

With reference to FIG. 4, an exemplary schematic diagram 400 is shown to illustrate multi-path dynamic testing, in accordance with an embodiment of the present invention. Initially, an initial trace 410 is performed by the actual processor during the testing of a program. Incident to detecting an indicator 420, a first fault may be injected. The indicator may be triggered to point to another portion of code within the program; thus, identifying a divergent execution path 430. As discussed above, a virtual processor is generated that executes instructions along the divergent execution path until a defect is detected. If the defect is a terminal failure, then the execution of instructions ceases 440. If the defect is not immediately harmful, then the execution of instructions continues along the divergent execution path 430.

If, while executing instructions on the divergent execution path, a second indicator 450 is encountered, a second divergent execution path 460 is established, and so on. In one embodiment, the virtual processor will proceed to execute instructions along the second divergent execution path 460 while concomitantly executing instructions in parallel on the initial divergent execution path 430 (i.e., nesting the divergent execution paths to facilitate multi-path dynamic testing). In another embodiment, execution along the initial divergent execution path 430 is paused until the virtual processor encounters a defect on the second divergent execution path 460. Upon encountering a defect on each divergent execution path 430, 460, the virtual processing function is ceased and the actual processing is resumed from a mark on the initial trace that is proximate to the indicator 420.

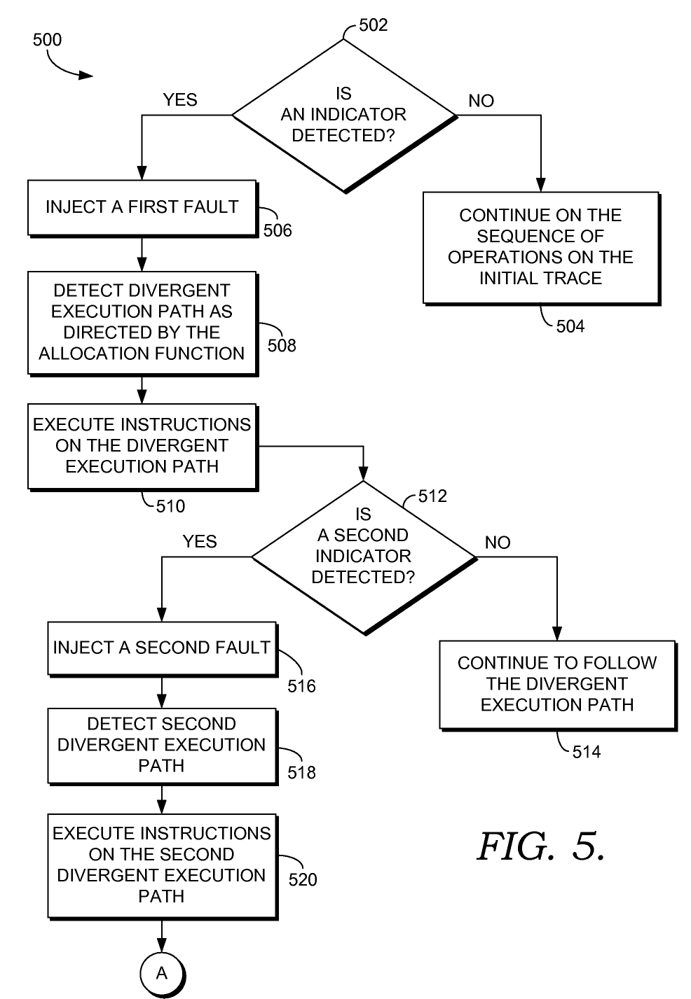

With reference to FIGS. 5 and 6, a flow diagram is illustrated that shows methods 500 and 600 for executing instructions on alternate, or nested, divergent execution paths, in accordance with embodiments of the present invention. In particular, referring to FIG. 5, a method 500 for establishing multi-path testing of a program is illustrated. Initially, a determination of whether an indicator is detected is performed, as indicated at block 502. If no indicator is detected, the actual processor continues to perform the sequence of operations as dictated by the program instructions on the initial trace. This is indicated at block 504.

Alternatively, if a indicator is detected, as indicated at block 506, a first fault is injected. Injection refers to slightly changing the dynamic execution state to simulate the effect of the processor diverting to an alternate execution path than the present path. By way of example only, a register value that is associated with a memory location is reduced to a zero value. As such, a memory failure at that location is detected by the allocation function. The allocation function will return a null pointer indicating that there is no capacity available to satisfy the allocation request. Additionally, the allocation function may discover capacity at an alternative memory location, i.e., divergent-execution paths. Upon detecting the divergent execution path(s) as directed by the allocation function (as indicated at block 508), the virtual processor may execute instructions on that divergent execution path (as indicated at block 510). By following the divergent execution path, the virtual processor is able to approximate the behavior of the actual processor had it diverted from the initial trace. Advantageously, this method promotes extensive testing that reports intermittent defects, which would have evaded discovery under standard testing procedures.

Next, a determination of whether a second indicator is detected is performed, as indicated at block 512. If no second indicator is detected, the virtual processor continues to follow the divergent execution path. This is indicated at block 514. Alternatively, if a second indicator is detected, as indicated at block 516, a second fault is injected. Upon detecting the second divergent-execution path (as indicated at block 518), the virtual processor may execute instructions on that second divergent execution path (block 520). Upon completing executing instructions on the second divergent execution, the virtual processor returns to finish executing instructions on the first execution path without injecting a second fault into the second indicator.

Referring now to FIG. 6, a method 600 for detecting a defect and resuming testing and dynamic analysis of the initial trace is illustrated, e.g., utilizing resumption module 220. Initially, a determination of whether a defect is detected is performed, as indicated at block 602. If no defect is detected, then the virtual processor continues to follow the second divergent execution path, as indicated at block 604. If a defect is detected, the virtual processor may return to the initial divergent execution path (as indicated at block 606) and execute instructions thereon (as indicated at block 608). Next, a determination of whether a defect is detected on the divergent execution path is performed, as indicated at block 610. If no defect is detected, the virtual processor continues to follow the divergent execution path. This is indicated at block 612. If a defect is detected, the virtual processor may cease executing instructions and allow the actual processor to return to conducting the sequence of operations of the initial trace, as indicated at block 614. It should be understood and appreciated by those of ordinary skill in the art that, although two divergent paths are demonstrated, an infinite number of divergent paths may be established. Further, the instructions of these paths may be executed by the virtual processor individually, in parallel, or a combination thereof.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

What is claimed is:

1. One or more computer storage media having computer-executable instructions embodied thereon that, when executed, perform a method for executing divergent execution paths associated with a program, the method comprising:
executing a first program execution path, the first program execution path having at least one point of divergence associated therewith that defines a second execution path;
generating a virtual processor having an execution state that emulates a dynamic execution state of the program at the point of potential divergence associated with the first program execution path;
executing a test trace along the second program execution path utilizing the virtual processor; and
storing information associated with the test trace and the second program execution path in association with at least one data store.

2. The one or more computer storage media of claim 1, wherein the point of divergence associated with the first program execution path comprises a point at which an allocation could have failed, a point at which a network operation could have returned a timeout, or a point at which a potential race condition could have occurred.

3. The one or more computer storage media of claim 1, wherein the method further comprises analyzing the information associated with the test trace to determine if at least one program defect is associated therewith.

4. The one or more computer storage media of claim 3, wherein the at least one program defect comprises a bug, a race condition, a memory leak, a fatal error, a buffer overrun, or a condition of use of uninitialized memory.

5. The one or more computer storage media of claim 1, wherein the dynamic execution state comprises at least one register value and at least one memory location associated with the dynamic execution state of the program.

6. The one or more computer storage media of claim 1, wherein executing a test trace along the second program execution path comprises injecting a fault condition into the first program execution path that causes the program to diverge along the second execution path at the at least one point of divergence.

7. The one or more computer storage media of claim 1, wherein the first program execution path and the second program execution path comprise instruction-level program execution paths.

8. A computer system embodied on one or more computer storage media having computer-executable instructions embodied thereon for performing a method for emulating execution of divergent execution paths associated with a program, the system comprising:
a program execution component configured for executing a plurality of instruction-level traces, each instruction-level trace being associated with a different program execution path;
a generating component configured for generating at least one virtual processing unit, the at least one virtual processing unit being associated with one of the plurality of instruction-level traces; and
an analysis component configured for analyzing information associated with the one of the plurality of instruction-level traces associated with the virtual processing unit.

9. The one or more computer storage media of claim 8, wherein the system further comprises a determining component configured for determining a dynamic execution state of the program at a point of divergence along at least one program execution path, and wherein the generating component is further configured for generating the at least one virtual processing unit having the determined dynamic execution state of the program.

10. The one or more computer storage media of claim 8, wherein the analysis component is further configured for cloning a dynamic analysis state associated with at least one program execution path, the information associated with the one of the plurality of instruction-level traces being analyzed using the cloned dynamic analysis state.

11. One or more computer storage media having computer-executable instructions embodied thereon that, when executed, perform a method for emulating execution of divergent program execution paths, the method comprising:
initiating a trace of a program along a first execution path, the first execution path having a point of potential divergence associated therewith that defines a second execution path;
determining a dynamic execution state of the program at the point of potential divergence associated with the first execution path;
generating a virtual processor having the dynamic execution state of the program at the point of potential divergence associated with the first execution path;
initiating a test trace along the second execution path utilizing the virtual processor; and
storing information associated with at least one of the test trace and the second execution path in association with at least one data store.

12. The one or more computer storage media of claim 11, wherein the point of potential divergence comprises a point at which an allocation could have failed, a point at which a network operation could have returned a timeout, or a point at which a potential race condition could have been detected.

13. The one or more computer storage media of claim 11, wherein the method further comprises analyzing the information associated with the at least one of the test trace and the second execution path to determine if at least one program defect is associated therewith.

14. The one or more computer storage media of claim 13, wherein the at least one program defect comprises a bug, a race condition, a memory leak, a fatal error, a buffer overrun, or a condition of use of uninitialized memory.

15. The one or more computer storage media of claim 13, wherein analyzing the information associated with the at least one of the test trace and the second execution path comprises:
identifying a dynamic analysis state associated with the first execution path; and
cloning the dynamic analysis state, wherein the information associated with the at least one of the test trace and the second execution path is analyzed utilizing the cloned dynamic analysis state.

16. The one or more computer storage media of claim 11, wherein the dynamic execution state of the program comprises at least one register value and at least one memory location associated therewith.

17. The one or more computer storage media of claim 11, wherein initiating a test trace along the second execution path comprises injecting a fault condition into the first execution path that causes the program to diverge along the second execution path at the point of potential divergence.

18. The one or more computer storage media of claim 11, wherein the trace and the test trace comprise instruction-level traces.

19. The one or more computer storage media of claim 11, wherein the second execution path includes a point of potential divergence associated therewith that defines a third execution path.

20. The one or more computer storage media of claim 19, wherein the method further comprises:
determining a dynamic execution state of the program at the point of potential divergence associated with the second execution path;
generating a second virtual processor having the dynamic execution state of the program at the point of potential divergence associated with the second execution path;
initiating a second test trace along the third execution path utilizing the second virtual processor; and
storing information associated with at least one of the second test trace and the third execution path in association with the at least one data store.
